(19) United States
(12) Patent Application Publication
(10) Pub. No.: US 2024/0346106 A1
(43) Pub. Date: Oct. 17, 2024

(54) SYMBOLIC MODEL DISCOVERY RECTIFICATION

(71) Applicant: INTERNATIONAL BUSINESS MACHINES CORPORATION, ARMONK, NY (US)

(72) Inventors: Lior Horesh, North Salem, NY (US); Cristina Cornelio, Kilchberg (CH); Sanjeeb Dash, Croton on Hudson, NY (US); Joao P. Goncalves, Wappingers Falls, NY (US); Kenneth Lee Clarkson, Madison, NJ (US); Nimrod Megiddo, Palo Alto, CA (US); Bachir El Khadir, White plains, NY (US); Vernon Ralph Austel, Cortlandt Manor, NY (US)

(21) Appl. No.: 18/298,727

(22) Filed: Apr. 11, 2023

(51) Int. Cl. G06F 17/11

(52) U.S. Cl. CPC G06F 17/11

(57) ABSTRACT

A method for obtaining a refined model given a mis-specified symbolic model. The method includes receiving a mis-specified symbolic model and data pertaining to a process or phenomenon corresponding to the mis-specified symbolic model; receiving one or more constraints; generating a plurality of partial expression trees based on the mis-specified symbolic model; solving an optimization problem for each of the partial expression trees; and determining a refined symbolic model of the mis-specified symbolic model based on results of the optimization problem for each partial expression tree.

### FEDERALLY SPONSORED RESEARCH OR DEVELOPMENT

This invention was made with government support under FA8750-18-C-0098 P00 awarded by Defense Advanced Research Projects Agency (DARPA). The government has certain rights to this invention.

### BACKGROUND

A symbolic model is a representation of a system or phenomenon using symbols or abstract concepts. These symbols can be mathematical or linguistic, and are used to describe the relationships between different variables or elements in the system.

Symbolic models are often used in various fields, including physics, engineering, and computer science to help understand complex systems and make predictions about how they will behave under different conditions. For example, a symbolic model of a mechanical system might use mathematical equations to describe the relationships between the various components of the system, while a symbolic model of a programming language might use abstract syntax trees to represent the structure of code.

Overall, symbolic models are an important tool for understanding and working with complex systems, and are widely used across a variety of disciplines.

### SUMMARY

The present disclosure includes various embodiments for obtaining a refined model given a mis-specified symbolic model. In an embodiment, the method includes receiving a mis-specified symbolic model and data pertaining to a process or phenomenon corresponding to the mis-specified symbolic model; receiving one or more constraints; generating a plurality of partial expression trees based on the mis-specified symbolic model; solving an optimization problem for each of the partial expression trees; and determining a refined symbolic model of the mis-specified symbolic model based on results of the optimization problem for each partial expression tree.

In an embodiment, generating the plurality of partial expression trees comprises replacing a leaf in a partial expression tree with a sub-expression tree.

In an embodiment, the refined model minimizes a model prediction error for the data pertaining to the process or phenomenon.

In an embodiment, the refined model maintains a bounded complexity distance from the mis-specified symbolic model specified in the one or more constraints.

In an embodiment, the refined model maintains a bounded numerical parameters difference specified in the one or more constraints.

In an embodiment, the refined model maintains a bounded functional form difference specified in the one or more constraints.

In an embodiment, the refined model adheres to symbolic grammatic constraints specified by the one or more constraints.

In an embodiment, the refined model has a higher fidelity than the mis-specified symbolic model.

In an embodiment, the refined model has a lower complexity than a symbolic model that is discovered without using the mis-specified symbolic model.

Other embodiments including a system and computer program product configured to perform the above method or various implementations of the above method are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating Kepler's 3rd Law.

FIG. 2 is a flowchart illustrating a process for obtaining a rectified model in accordance with an embodiment of the present disclosure.

FIG. 3 is an example of an expression tree in accordance with an embodiment of the present disclosure.

FIG. 4 is an example of a partial expression tree in accordance with an embodiment of the present disclosure.

FIG. 5 is an example of modifying a partial expression tree in accordance with an embodiment of the present disclosure.

FIG. 6 is a block diagram illustrating a hardware architecture of a system according to an embodiment of the present disclosure in which aspects of the illustrative embodiments may be implemented.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to.” Unless otherwise indicated, as used throughout this document, “or” does not require mutual exclusivity, and the singular forms “a”, “an” and “the” are intended to include the plural forms as well, unless the context clearly indicates otherwise.

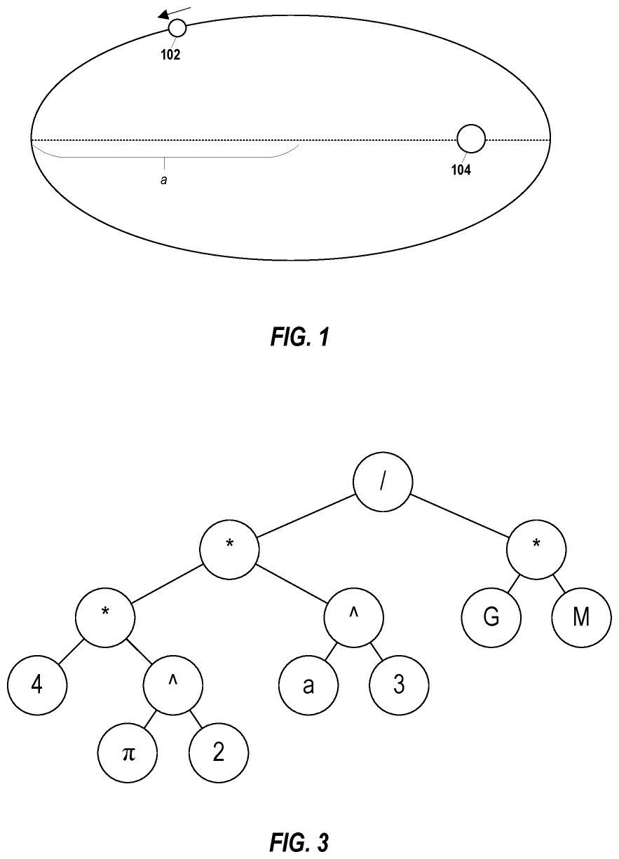

A symbolic model is a type of mathematical model that uses abstract symbols and variables to represent the components of a system or phenomenon. For example, ƒ=ma is a symbolic model of Newton's second law of motion, where ƒ represents force, m represents the mass of an object, and a represents acceleration. In some cases, the equations used in symbolic models may not have a direct physical interpretation, but they are used to describe the behavior of the system in terms of mathematical relationships or logical rules. For example, Kepler's 3rd Law is a symbolic model that describes the relationship between the orbital period and the semi-major axis (a) of a planet 102 in terms of the mass of the star 104 it orbits as illustrated in FIG. 1. The law was derived by Johannes Kepler in the early 17th century based on his observations of the motions of the planets in the solar system. The orbital period of the planet 102 to the sun 104 can be described according to Kepler's 3rd Law, using the following Equation 1:

$${T}^{2} = \frac{4 {π}^{2} {a}^{3}}{G ( M )} \qquad Equation 1$$

In Equation 1, T is the orbital period of the planet 102, x is the mathematical constant pi (approximately equal to 3.14159), a is the semi-major axis of the orbit of the planet 102, G is the gravitational constant, M is the mass of the star 104 (e.g., the sun). Kepler's 3rd Law applies when the mass of the planet 102 is less than the mass of star 104. Based on Kepler's 3rd Law, the farther a planet is from its star, the longer its orbital period will be. The law also implies that planets around more massive stars have shorter orbital periods than planets around less massive stars.

Other examples of symbolic models include Debye and Cole-Cole models that are used to describe the dielectric properties of materials. The Debye model describes the dielectric behavior of a material as a function of frequency. The Debye model assumes that the material is composed of a large number of polarizable molecules or dipoles that can be modeled as simple harmonic oscillators. The Debye model assumes that these oscillators are independent and that the dielectric constant of the material varies as a function of frequency according to Equation 2:

$$ε ( ω ) = {ε}_{∞} + \frac{{ε}_{s} - {ε}_{∞}}{1 - i ω τ} \qquad Equation 2$$

In Equation 2, ε(ω) is the complex permittivity of the material at frequency ω, ε_{∞} is the permittivity of the material at infinite frequency (also known as the high-frequency permittivity) εₛ is the static permittivity of the material (also known as the low-frequency permittivity), and τ is the relaxation time of the material.

The Cole-Cole model extends the Debye model by accounting for the effect of frequency dispersion on the dielectric properties of materials when more complex spectral relaxations are involved. The Cole-Cole assumes that the polarizable dipoles in the material are not independent but are instead coupled through intermolecular interactions. The Cole-Cole model also assumes that the dielectric constant of the material varies as a function of frequency according to Equation 3:

$$ε ( ω ) = {ε}_{∞} + \frac{{ε}_{s} - {ε}_{∞}}{1 - i ω {τ}^{1 - α}} \qquad Equation 3$$

where α is a parameter that describes the width of the relaxation spectrum.

Even though the above models are well known, they are not perfect and may convey imperfect representations of reality either due to incomplete physical description of the underlying phenomenon (simplified governing equations, defective boundary conditions, etc.), or due to numerical approximations (discretization, linearization, round-off error, etc.). This imperfection is referred to as noise, which produces a mis-specified symbolic model. Stated otherwise, noise is anything that cannot be explained or represented in a model. Therefore, the true process observation=a mis-specified model+noise. Thus, a mis-specified symbolic model is a symbolic model that does not fully represent the true process observation being modeled due to the noise factor. In some cases, a mis-specified symbolic model can lead to erroneous model predictions, and respectively suboptimal decisions associated with the intended end-goal task. Therefore, the smaller the noise factor is, the closer the mis-specified model is to the true process observation.

The present disclosure seeks to improve symbolic models by reducing the noise factor. In particular, the noise factor may be broken down into epistemic errors and aleatory errors (e.g., noise=epistemic error+aleatory error). Epistemic errors are errors based on the mis-specified symbolic model and may arise from a lack of knowledge or understanding about a system or process. Examples of epistemic errors include modeling assumptions that do not accurately reflect reality, incorrect parameter values, and incomplete data sets. Aleatory errors are errors that arise from the inherent randomness or variability in a system or process. Aleatory errors are often due to natural variability or unpredictability, such as random fluctuations in weather patterns, variations in environmental conditions, manufacturing variability, or statistical sampling errors. In general, due to the randomness or unpredictability of aleatory errors, they cannot be controlled (i.e., reduced). Whereas epistemic errors can, in some cases, be reduced and thus improve a mis-specified symbolic model.

In an embodiment of the present disclosure, prior knowledge used in obtaining a mis-specified symbolic model is incorporated with additional data (e.g., new data or experimental data of sufficient level of fidelity) to enable the discovery of non-trivial relationships that further refine the mis-specified symbolic model (e.g., by reducing epistemic errors) to produce a rectified symbolic model with higher fidelity (i.e., closer to the true process observation) than the mis-specified symbolic model. Thus, a rectified or refined symbolic model is a mis-specified symbolic model that has been refined to improve its accuracy, applicability, or some other constraint.

In an embodiment, the original discovery of a symbolic model can be represented as an optimization problem of the following form:

$${f}_{{θ}_{d} , {θ}_{c}} = arg min \{ D ( {f}_{{θ}_{d} , {θ}_{c}} ( x ) , y ) \} \qquad Equation 4$$

$$C ( {f}_{{θ}_{d} , {θ}_{c}} ) \leq τ \qquad Equation 5$$

$${f}_{{θ}_{d} , {θ}_{c}} ∈ T \qquad Equation 6$$

Equation 4 represents the fidelity or accuracy of the symbolic model, where ƒ_{θ}_{_{d}}_{,θ}_{_{c}} is a symbolic model presented by the function ƒ that is defined by set of discrete parameters represented by θ_{d} (e.g., pertaining to the functional form) and continuous or constant parameters represented by θ_{c} (e.g., the gravitational constant (G)=6.67408×10⁻¹¹ Nm²/kg²). The symbolic model is evaluated at a given datum point x, where the outcome/prediction of the symbolic model is close to the true observation y within some measure of distance D.

Equation 5 represents a complexity constraint applied to the symbolic model, where C(ƒ_{θ}_{_{d}}_{,θ}_{_{c}}) represents the complexity, and τ represents a complexity threshold. For example, the complexity of the symbolic model can be limited by the depth of the expression tree that describes the model are the number of operators (e.g., addition, subtraction, multiplication, etc.) that are included in the symbolic model. An expression tree is a tree-like data structure that represents mathematical expressions or formulas. In an expression tree, the nodes represent operators or operands, and the branches represent the dependencies or the relationships between them.

Equation 6 represents a grammar constraint applied to the symbolic model requiring that the symbolic model is grammatically correct. For example, a symbolic model cannot have as part of its function or expression tree x++y since the operator ++ is not a tangible grammatic syntactic representation of a symbolic model. Thus, using Equations 5-7, the symbolic model must meet the desired fidelity, the optimization problem can search for symbolic models that are syntactically viable that also specifies the fidelity constraint requirements.

In accordance with the present disclosure, using the symbolic model ƒ_{θ}_{_{d}}_{,θ}_{_{c}}, an embodiment determines a refined or rectified model \tilde{ƒ}_{\tilde{θ}}_{_{d}}_{,\tilde{θ}}_{_{c}} that is bounded by a complexity extension Δτ according to the following equations:

$${\tilde{f}}_{{\tilde{θ}}_{d} , {\tilde{θ}}_{c}} = arg min \{ D ( {\tilde{f}}_{{\tilde{θ}}_{d} , {\tilde{θ}}_{c}} ( x ) , y ) \} \qquad Equation 7$$

$$p ( C ( {\tilde{f}}_{{\tilde{θ}}_{d} , {\tilde{θ}}_{c}} ) , \qquad Equation 8$$

$$C ( {f}_{{θ}_{d} , {θ}_{c}} ) ) \leq Δτ$$

$${μ}_{c} ( {\tilde{θ}}_{c} , {θ}_{c} ) \leq {τ}_{c} \qquad Equation 9$$

$${μ}_{d} ( {\tilde{θ}}_{d} , {θ}_{d} ) \leq {τ}_{d} \qquad Equation 10$$

$${\tilde{f}}_{{\tilde{θ}}_{d} , {\tilde{θ}}_{c}} ∈ T \qquad Equation 11$$

Equation 7 is similar to Equation 4 of the symbolic model ƒ_{θ}_{_{d}}_{,θ}_{_{c}}, in that the fidelity of the rectified model \tilde{ƒ}_{\tilde{θ}}_{_{d}}_{,\tilde{θ}}_{_{c}} (i.e., prediction error) should be minimize. Equation 8 specifies that the difference (Δ) between the complexity of the symbolic model ƒ_{θ}_{_{d}}_{,θ}_{_{c}} and the rectified model \tilde{ƒ}_{\tilde{θ}}_{_{d}}_{,\acute{θ}}_{_{c}} should be less than a complexity threshold (τ). In other words, the complexity of the rectified model \tilde{ƒ}_{\tilde{θ}}_{_{d}}_{,\tilde{θ}}_{_{c}} should be somewhat close to the complexity of the original symbolic model ƒ_{θ}_{_{d}}_{,θ}_{_{c}}. Equation 9 specifies that the difference between the numerical parameters (e.g., constant values) of the symbolic model ƒ_{θ}_{_{d}}_{,θ}_{_{c}} and the rectified model \tilde{ƒ}_{\tilde{θ}}_{_{d}}_{,\tilde{θ}}_{_{c}} should be less than a numerical parameters difference threshold (τ_{c}). Similarly, Equation 10 specifies that the difference between the functional form (e.g., the structure of the expression tree) of the symbolic model ƒ_{θ}_{_{d}}_{,θ}_{_{c}} and the rectified model \tilde{ƒ}_{\tilde{θ}}_{_{d}}_{,\tilde{θ}}_{_{c}} should be less than a functional form difference threshold (τ_{d}). Additionally, Equation 11 specifies that the rectified model \tilde{ƒ}_{\tilde{θ}}_{_{d}}_{,\tilde{θ}}_{_{c}} should have grammatical consistency.

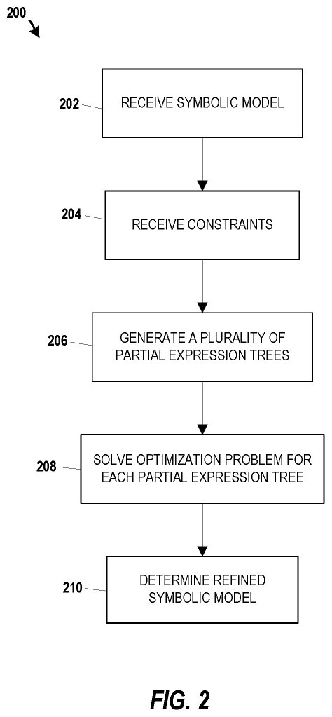

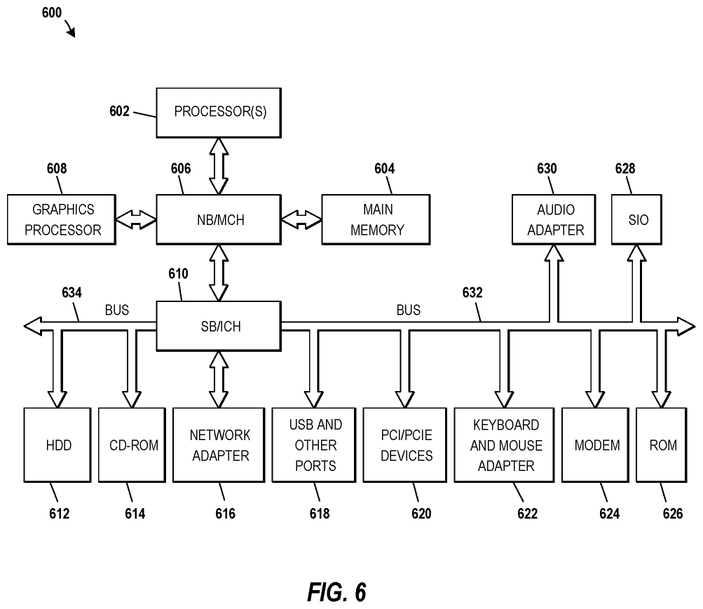

FIG. 2 is a flowchart illustrating a process 200 for obtaining a rectified model in accordance with an embodiment of the present disclosure. The process 200 may be written as instructions in one or more programming languages and stored in memory, or a computer readable medium, and executed using one or more processors of a system (e.g., system 600 in FIG. 6). The process 200 begins at step 202 by receiving a symbolic model to be refined. As an example, assume the process 200 receives Kepler's 3rd Law (i.e., Equation 1) as the to-be-refined symbolic model.

At step 204, the process receives a set of constraints or bounds that the rectified model is to satisfy. As stated above, the set of bounds may include a structural form difference limit or threshold, a numerical parameters difference threshold, a fidelity requirement, and a grammatical consistency requirement.

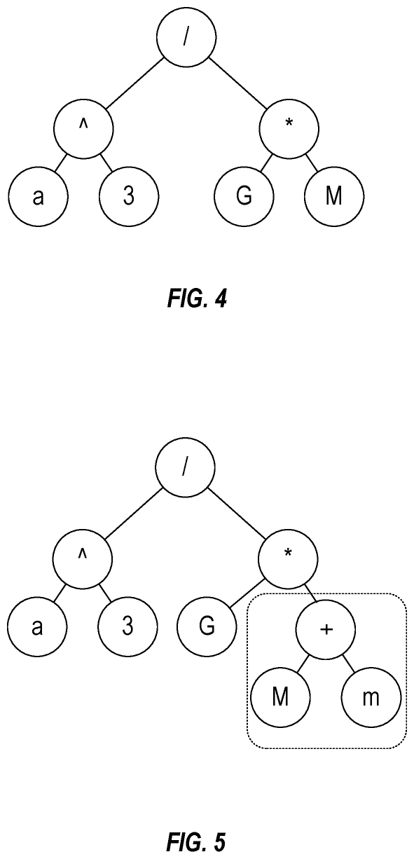

At step 206, the process 200 generates a plurality of partial expression trees that have the potential to form refined models of the given symbolic model based on the expression tree of the given symbolic model. For instance, the expression tree for Kepler's 3rd Law is illustrated in FIG. 3. As shown in FIG. 3, Equation 1 is depicted as a treelike structure where the nodes represent operators or operands (e.g., multiplication (*), division (/), and exponential (\hat{ })), and the branches represent the dependencies or the relationships between them. As stated above, based on this base functional form (i.e., the expression tree with no values for its parameters) of the given symbolic model, the process 200 enumerates a plurality of partial expression trees that have the potential to form refined models of the given symbolic model. A partial expression tree, unlike a complete expression tree, only contains a subset of the nodes that make up the full expression. For instance, FIG. 4 illustrates one example of a partial expression tree for Kepler's 3rd Law, where only the variables a, G, and M are represented in the partial expression tree. Various other partial expression trees for Kepler's 3rd law may be generated (e.g., with just variables G and M) in the plurality of personal expressions trees and may be used to form refined models of the original symbolic model.

In an embodiment, additional partial expression trees are generated by replacing one or more leaves in a partial expression tree or expression tree (e.g., a leaf containing a variable) with a sub-expression tree. For example, FIG. 5 illustrates a partial expression tree where the leaf representing M is replaced with a subexpression tree of (M+m). In other words, the mass of the star M in Kepler's 3rd law is replaced by the mass of the star M plus the mass of the planet m. Alternatively, in other partial expression trees (not depicted), the leaf representing M is replaced with a subexpression tree of (M*m) or (M−m). Similarly, other leaves the expression tree in Kepler's 3rd law may be replaced with other sub-expression trees within the constraints or bounds (e.g., structural form limit bounds) specified for the refined symbolic model.

At step 208, the process 200 solves an optimization problem for each partial expression tree to find the set of input values that maximize or minimize a given objective function, subject to the set of constraints. For example, when a leaf is replaced with a sub-expression tree, where the values of the variables for the leaves in the subexpression tree are unknown, the process 200 solves an optimization problem to determine the best values/choice for are each unknown variable to identify the optimum variables of the leaves in the sub-expression tree for modifying the original expression tree of the symbolic model within the specified constraints. In some embodiments, there may be one or more solutions that satisfy these conditions depending on the problem. The process of solving an optimization problem typically involves identifying the properties of the objective function and constraints, such as structural form limit, numerical difference threshold, grammatical consistency, and selecting an appropriate optimization algorithm that can efficiently and reliably find a solution that meets the desired criteria. Common optimization algorithms include gradient descent, Newton's method, linear programming, and quadratic programming.

At step 210, the process 200 determines the refined or rectified symbolic model based on the results of the optimization problem for each partial expression tree. For example, for Kepler's 3rd Law (Equation 1), using the disclosed embodiments on a set of synthetic data, a refined model of Kepler's 3rd Law is shown in Equation 12:

$${T}^{2} = \frac{4 {π}^{2} {a}^{3}}{G ( M + m )} \qquad Equation 12$$

In Equation 12, the refined model account is close in complexity to the original mis-specified model (Equation 1), except it replaces the mass of the star with the total mass of the star and the planet. The refined model more accurately reflects the true process observation. In the case of a planet orbiting the sun, the original mis-specified model (Equation 1) was satisfactory because the mass of a planet m was negligible compared to the mass of the sun M, thus there is not much difference between M and M+m. However, the refined model more accurately reflects the true process observation especially when the mass of M is not so substantially more than m (e.g., a moon orbiting a planet).

It should be noted that it is possible to determine an even more accurate symbolic model/equation when starting from scratch (i.e., without using a misspecification model was a base). However, the more accurate symbolic model is likely to be more complex and thus making it more difficult to understand. For instance, for Kepler's 3rd Law, the following Equation 13, determined without using a mis-specified model as a base, has a slightly lower prediction error than Equation 12:

$${T}^{2} = \frac{1}{G ( M + m ) {( \frac{1}{a} + \frac{61.0295}{{GMm}^{2}} )}^{3}} \qquad Equation 13$$

As shown above, Equation 13 is more complex than the refined model (Equation 12), which closely resembles the original mis-specified symbolic model of Kepler's 3rd Law.

It should be also noted that using different data sets (e.g., real data set as opposed to synthetic data set) other forms of a refined model based on the original mis-specified model of Kepler's 3rd law (Equation 1) may be determined. For example, using embodiments of the present disclosure and real data from the National Aeronautics and Space Administration (NASA) exoplanet dataset, a refined symbolic model of

$${T}^{2} = \frac{{( d - 0.0356 m )}^{3}}{G ( M + m )}$$

is determined and returns a solution with error 0.19. Other refined symbolic models may be determined using a different data set.

It should be further noted that although the symbolic model of Kepler's 3rd law is described as an example in the present disclosure, the disclosed embodiments can be applied to any mis-specified model to enable the discovery of a refined or rectified model.

Thus, the disclosed embodiments provide various systems and methods for producing a refined symbolic model bounded by a set of constraints of a given mis-specified symbolic model.

FIG. 6 is a block diagram illustrating a hardware architecture of a system 600 according to an embodiment of the present disclosure in which aspects of the illustrative embodiments may be implemented. For example, in an embodiment, the process 200 described in FIG. 2 may be implemented using the data processing system 600. In the depicted example, the data processing system 600 employs a hub architecture including north bridge and memory controller hub (NB/MCH) 606 and south bridge and input/output (I/O) controller hub (SB/ICH) 610. Processor(s) 602, main memory 604, and graphics processor 608 are connected to NB/MCH 606. Graphics processor 608 may be connected to NB/MCH 606 through an accelerated graphics port (AGP). A computer bus, such as bus 632 or bus 634, may be implemented using any type of communication fabric or architecture that provides for a transfer of data between different components or devices attached to the fabric or architecture.

In the depicted example, network adapter 616 connects to SB/ICH 610. Audio adapter 630, keyboard and mouse adapter 622, modem 624, read-only memory (ROM) 626, hard disk drive (HDD) 612, compact disk read-only memory (CD-ROM) drive 614, universal serial bus (USB) ports and other communication ports 618, and peripheral component interconnect/peripheral component interconnect express (PCI/PCIe) devices 620 connect to SB/ICH 610 through bus 632 and bus 634. PCI/PCIe devices may include, for example, Ethernet adapters, add-in cards, and personal computing (PC) cards for notebook computers. PCI uses a card bus controller, while PCIe does not. ROM 626 may be, for example, a flash basic input/output system (BIOS). Modem 624 or network adapter 616 may be used to transmit and receive data over a network.

HDD 612 and CD-ROM drive 614 connect to SB/ICH 610 through bus 634. HDD 612 and CD-ROM drive 614 may use, for example, an integrated drive electronics (IDE) or serial advanced technology attachment (SATA) interface. In some embodiments, HDD 612 may be replaced by other forms of data storage devices including, but not limited to, solid-state drives (SSDs). A super I/O (SIO) device 628 may be connected to SB/ICH 610. SIO device 628 may be a chip on the motherboard configured to assist in performing less demanding controller functions for the SB/ICH 610 such as controlling a printer port, controlling a fan, and/or controlling the small light emitting diodes (LEDS) of the data processing system 600.

The data processing system 600 may include a single processor 602 or may include a plurality of processors 602. Additionally, processor(s) 602 may have multiple cores. For example, in one embodiment, data processing system 600 may employ a large number of processors 602 that include hundreds or thousands of processor cores. In some embodiments, the processors 602 may be configured to perform a set of coordinated computations in parallel.

An operating system is executed on the data processing system 600 using the processor(s) 602. The operating system coordinates and provides control of various components within the data processing system 600 in FIG. 6. Various applications and services may run in conjunction with the operating system. Instructions for the operating system, applications, and other data are located on storage devices, such as one or more HDD 612, and may be loaded into main memory 604 for execution by processor(s) 602. In some embodiments, additional instructions or data may be stored on one or more external devices. The processes described herein for the illustrative embodiments may be performed by processor(s) 602 using computer usable program code, which may be located in a memory such as, for example, main memory 604, ROM 626, or in one or more peripheral devices.

The disclosed embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the disclosed embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a mis-specified symbolic model and data pertaining to a process or phenomenon corresponding to the mis-specified symbolic model;
receiving one or more constraints;
generating a plurality of partial expression trees based on the mis-specified symbolic model;
solving an optimization problem for each of the partial expression trees; and
determining a refined symbolic model of the mis-specified symbolic model based on results of the optimization problem for each partial expression tree.

2. The method of claim 1, wherein generating the plurality of partial expression trees comprises replacing a leaf in a partial expression tree with a sub-expression tree.

3. The method of claim 1, wherein the refined model minimizes a model prediction error for the data pertaining to the process or phenomenon.

4. The method of claim 1, wherein the refined model maintains a bounded complexity distance from the mis-specified symbolic model specified in the one or more constraints.

5. The method of claim 1, wherein the refined model maintains a bounded numerical parameters difference specified in the one or more constraints.

6. The method of claim 1, wherein the refined model maintains a bounded functional form difference specified in the one or more constraints.

7. The method of claim 1, wherein the refined model adheres to symbolic grammatic constraints specified by the one or more constraints.

8. The method of claim 1, wherein the refined model has a higher fidelity than the mis-specified symbolic model.

9. The method of claim 1, wherein the refined model has a lower complexity than a symbolic model that is discovered without using the mis-specified symbolic model.

10. The method of claim 1, further comprising:
receiving testing data; and
performing a prediction using the refined symbolic model based on the testing data.

11. A system comprising memory for storing instructions, and a processor configured to execute the instructions to:
receive a mis-specified symbolic model and data pertaining to a process or phenomenon corresponding to the mis-specified symbolic model;
receive one or more constraints;
generate a plurality of partial expression trees based on the mis-specified symbolic model;
solve an optimization problem for each of the partial expression trees; and
determine a refined symbolic model of the mis-specified symbolic model based on results of the optimization problem for each partial expression tree.

12. The system of claim 11, wherein generating the plurality of partial expression trees comprises replacing a leaf in a partial expression tree with a sub-expression tree.

13. The system of claim 11, wherein the refined model minimizes a model prediction error for the data pertaining to the process or phenomenon.

14. The system of claim 11, wherein the refined model maintains a bounded complexity distance from the mis-specified symbolic model specified in the one or more constraints.

15. The system of claim 11, wherein the refined model maintains a bounded numerical parameters difference specified in the one or more constraints.

16. The system of claim 11, wherein the refined model maintains a bounded functional form difference specified in the one or more constraints.

17. The system of claim 11, wherein the refined model adheres to symbolic grammatic constraints specified by the one or more constraints.

18. The system of claim 11, wherein the refined model has a higher fidelity than the mis-specified symbolic model.

19. The system of claim 11, wherein the refined model has a lower complexity than a symbolic model that is discovered without using the mis-specified symbolic model.

20. A computer program product comprising a computer readable storage medium having program instructions embodied therewith, the program instructions executable by a processor of a system to cause the system to:
receive a mis-specified symbolic model and data pertaining to a process or phenomenon corresponding to the mis-specified symbolic model;
receive one or more constraints;
generate a plurality of partial expression trees based on the mis-specified symbolic model;
solve an optimization problem for each of the partial expression trees; and
determine a refined symbolic model of the mis-specified symbolic model based on results of the optimization problem for each partial expression tree.
